(19) United States
(12) Patent Application Publication
(10) Pub. No.: US 2004/0182968 A1
(43) Pub. Date: Sep. 23, 2004

(54) Traction kite harness safety release

(76) Inventor: Donald Christy Gentry, Corpus Christi, TX (US)

Correspondence Address: Donald C. Gentry, 15373 Isabella Ct., Corpus Christi, TX, 78418, US

(21) Appl. No.: 10/391,916

(22) Filed: Mar. 19, 2003

(51) Int. Cl. F41J 9/08; A63H 27/08; B64C 31/06

(52) U.S. Cl. 244/155 A

(57) ABSTRACT

A system of devices designed to release the harness lines from a rider's seat harness when rider releases the control bar (36), including a sensor strip (62), ratchet reel (70), harness line (68) and release cam (108). The system may also employ other embodiments with different operating mechanisms, all which accomplish the design objective.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of the Invention

The invention relates to traction kite flying. More specifically, it relates to traction kite use where the operator is attached to the kite by a harness.

Relevant Background

Traction kites may be used to propel any land or water vehicle where there is a large, open area to be traversed, and a sustained wind, usually in excess of 16 kph (10 mph). Sports are currently the predominant use. In most land sports, and on ice or snow, relatively light traction force is required to pull the rider, and there is not usually enough traction to unduly tire the arms without the use of a harness. This is generally not true in water-towed devices.

The rider reduces fatigue by attaching himself to the kite by a seat or waist harness-mounted bar with a downward and inwardly projecting hook or roller which is passed over a harness line. Normally the rider may unhook from his harness line by pulling inward and downward on the control bar, allowing the harness line to drop away from his hook.

The term “harness” is used in the sport to refer to both the seat or waist encircling web material which the rider wears and to the lines, usually stiffened by plastic tubing, which are attached to the kite leader line or control bar as described below. The term “front”, or “forward” (unless used to differentiate the set of kite lines referred to), means toward the kite, whereas “back” or “behind” means toward the rider.

2. Prior Art

The replacement of a harness hook with a roller is open domain, the most recent noted patent was issued to Kevin Williams, of Sunriver, Oreg., filed Sep. 23, 1991.

There are two types of harness line which may be engaged by the waist-mounted hook or roller. One is attached at both ends directly to the control bar. This type is used with two-line kites, and may be used with four line kites, although it is mostly redundant when used in addition to the type described below.

The other type of harness is used on kites with additional lines which are used to adjust the traction power of the kite. The most commonly used power control lines, 2 in number, are attached to the tips of the leading edge of the kite. The other ends are both attached to a short leader rope, which passes through a hole in, or guide on, the control bar. Then it terminates in an attachment to the front line leader loop, or chicken loop (FIGS. 2 and 4). When these lines are pulled more tightly than the rear (steering) lines (attached to the kite trailing edge tips) the pitch attitude of the kite is decreased, thus reducing lift, and resultant traction. The term “front lines” will be used hereinafter to mean the de-powering lines.

When the rider experiences a gust of stronger wind, the bar tends to pull away from him. As this occurs, the front lines are selectively tightened, as they are rigidly attached to the rider's harness. This results in an automatic de-powering of the kite, which may be augmented by the rider, by voluntarily extending his arms away from his body. A similar version of this power adjustment by the chicken loop is shown by John Bellacera, PCT Number WO O2/40124 A1, published 23 May 2002. Some riders prefer to use a quick-release snap instead of the chicken loop to attach their seat harness to the front lines leader rope. In this case the release cord or knob on the snap device must be found by feel, grasped and pulled to release from the fully powered kite. This can be very difficult while being violently dragged by an out-of-control kite.

There is some need to adjust the length of the front lines further than they may easily be altered simply by bar movement inward or outward. For this purpose, an adjustment strap is usually provided between the front lines attachment point, and the control bar. This adjustment strap can adjust the line length to the riders comfort, and may be used by some riders as the sole means of power adjustment. Possibly the adjustment strap of Daniel Prentice, U.S. Pat. No. 6,056,243, issued May 2, 2000, was the origin of the power adjustment strap.

High aspect ratio kites (high span to chord ratio) are more efficient for going upwind, but are much more difficult to launch from the water. When the kite lands in, or assumes a leading-edge-down position in the water, the rider often must pull in selectively on the front lines for several feet, and then release the slack during a gust. This is to get the kite to flip onto its back so that it may be relaunched. This often requires dropping the bar to pull hand-over-hand. Often, when the rider releases slack, the slack will be wound around the bar, or otherwise tangled. The launch opportunity is often lost due to this tangling and tumbling of the control bar. There is the opportunity for injury should the kite launch during this tangle.

The sport as currently practiced, is significantly more dangerous than most other wind and/or water sports, and there have been several deaths and innumerable injuries worldwide. One of the greatest sources of injury is being dragged by the harness attached to a fully powered kite, and unable to release before striking an object. The automatic reaction of a rider when losing control is to release the bar. If he has not previously un-hooked from the harness line, he is not able to easily regain his grip on the bar to do so, and it is very difficult to unhook while being dragged without the control bar in hand. Most often the dragging terminates by the uncontrolled kite crashing into the water, usually resulting in a cessation, or at least a pause, in the traction force. The kite sometimes does not crash before the rider is injured.

Some riders use a kite leash, to prevent loss of the kite if the un-harnessed rider releases his grip on the bar. This leash is attached to the rider's wrist in most cases, and the other end is attached to one of the kite lines, so that in the event the bar is dropped, the rider remains attached to one line of the kite, thereby collapsing the kite and releasing almost all traction from the rider. Nishimura, et. al. improved upon the prior art leash by a sliding leader line device, in U.S. Pat. No. 6,273,369, issued Aug. 14, 2001. This device, however, does not provide any means of releasing the power from the kite should the rider fall while attached to the harness line.

Harness Releases

One type of hook has been developed which snaps outward, thus releasing the harness line, when traction forces exceed a set level. The rider can adjust the amount of force the hook will sustain before snapping outward. This device has some of the advantage of the present invention because it requires no action by the rider other than the release of the control bar. The distinct disadvantage is that the device will open when the set limits are exceeded, releasing the rider unexpectedly. If the rider has a relaxed grip on the bar, it may be pulled from his hands, resulting in a fall and crash of the kite. Normal forces applied to the hook during a deliberate jump, or when cutting hard in riding to move upwind often far exceed those which can drag a rider uncontrollably over the water. I know of no documentation of this device. It was marketed about a decade ago under the trade name “Toucan”.

I developed and briefly marketed a hook-release device which required only a strike from the hand to allow the hook to flip up release the harness line in May, 2001, but I decided that the time and presence of mind required to strike the device in an emergency would preclude its effective use in many cases, so I withdrew the device from sale.

Another type of release is applied directly to the chicken loop to open it when a strap or knob is pulled. This device is available from at least one manufacturer, Cabrinha Designs Company of Maui, Hi. This device gives the rider no unintended releases, but often he is being thrashed into and out of the water, arms flailing, and may be unable to find and pull the release quickly. This same situation may occur when the snap type quick-release is used in place of the chicken loop. The delay of even a second or two may result in serious injury or death.

Except for the “Toucan”, no device has been found in prior art for releasing the harness line simply by dropping the control bar. Also, no device appears to exist in the prior art for simplifying relaunching high aspect ratio kites by selectively reeling in and releasing the front lines.

### DESCRIPTION OF THE PRIOR ART DRAWINGS

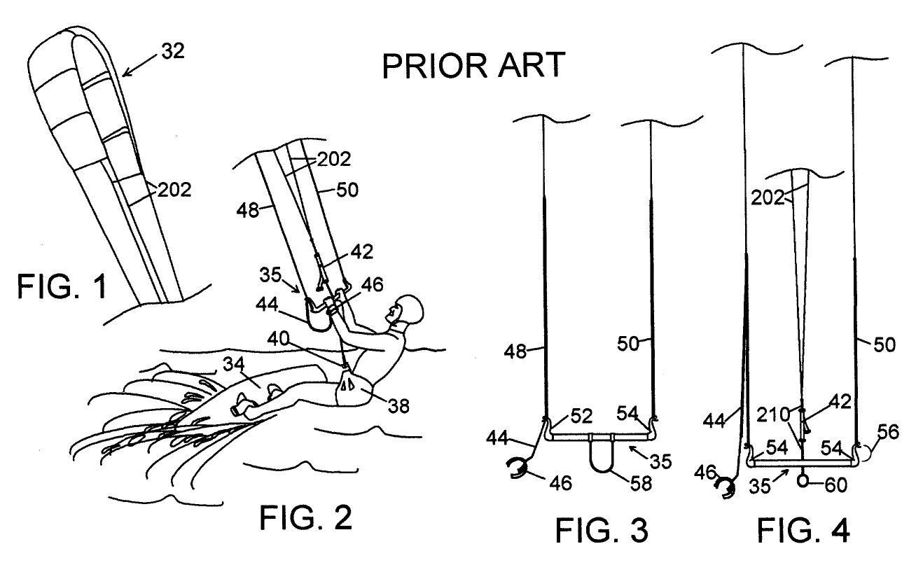

In FIG. 1-4, prior art is shown. In FIG. 1, the inflatable bladder traction kite 32 is shown with the inflatable leading edge to the right side. The kite lines extending from this leading edge are the front lines 202.

The rider planes on a kite-board 34, which in this drawing is of the bidirectional type, although any type may be used.

The kite is steered to the rider's right by pulling right steering line leader rope 50, or to the left by pulling on left steering line leader rope 48. This is done by pulling on the corresponding end of control bar 35. In FIG. 2, riders seat harness 38 is attached to a spreader bar, with attached roller 40. Roller 40 is hooked in to chicken loop 60, best shown in FIG. 4. Forward of control bar 35, front line adjustment strap 42 may be used to adjust length of leader rope 210 to front lines 202. Alternatively, when riding a 2-line kite, rider uses an alternate configuration of control bar 35, shown in FIG. 3 with harness line 58 fixed to control bar. This harness 58 is used in place of loop 60 for attachment to hook or roller 40.

The left leader rope 48 is usually attached to a kite leash 44, which may attach at some distance forward of the control bar 35 as in FIG. 4. Alternatively, it may be attached to the end of leader rope 48, so that it may pull leader line 48 through sliding-line end fixture 52. Forward side of bar is limited by a common knot where leader line 48 is attached to left kite line. Either arrangement serves to collapse the kite by pulling only on the left steering line by leader 48, while allowing the other lines to slacken as the released bar moves forward Left side bar end fixtures, when sliding leader lines 52 are not used, have a fixed line attachment 54 as do right bar ends.

All bar ends are provided with a concavity facing laterally, the line winder space 56, although it is shown only on the right end of bar 36 in FIG. 4, to avoid crowding of reference lines and numerals. This space is used to wind all kite lines in parallel, lengthwise on or parallel to bar 35 when kite is collapsed and reeled in.

### BRIEF SUMMARY OF THE INVENTION

The present invention is a system of devices designed to release the rider's harness hook or roller from attachment to the kite by only having to release his grip on the control bar. It will not release from high forces being applied to the harness as long as the rider maintains his grip on the bar. One embodiment of this will allow a rider to quickly adjust steering line length at the control bar. This achieves the same effect as the power adjustment strap of prior art, which is that of changing the lengths of steering lines relative to the front lines. Another embodiment of this release device allows the prior art adjustment strap to be used.

The preferred embodiment of this release device for 4-line kites provides a different means of adjusting the front lines. It also provides a safer means for pulling in several feet of front lines and then quickly releasing them, to re-launch high aspect-ratio kites from the water. Instead of hauling in the lines hand-over-hand, the front lines are reeled in, thereby reducing the number of slack lines in the water and the need to release the bar.

There are other embodiments, either fluid-actuated or mechanical, for releasing the harness line of 2 line kites, and for allowing bar spinning to untwist kite lines.

All embodiments have a provision for disabling the release, so the rider can, when desired, release the handle without activating the harness release. The disabling means of the preferred embodiment is noticeable and palpable in the grip area so it is not accidentally left in the disabling position.

### BRIEF DESCRIPTION OF THE SEVERAL VIEWS OF THE DRAWINGS—FIGURES

FIG. 1 is a perspective view of a traction kite in operation.

FIG. 2 is a perspective view of a person riding a kiteboard.

FIG. 3 is a plan view showing a prior art 2-line kite control bar, fixed harness, and lines with a sliding-line type kite leash.

FIG. 4 is a plan view showing a prior art 4-line control bar and lines with a forward-attached separate kite leash line and chicken loop type harness.

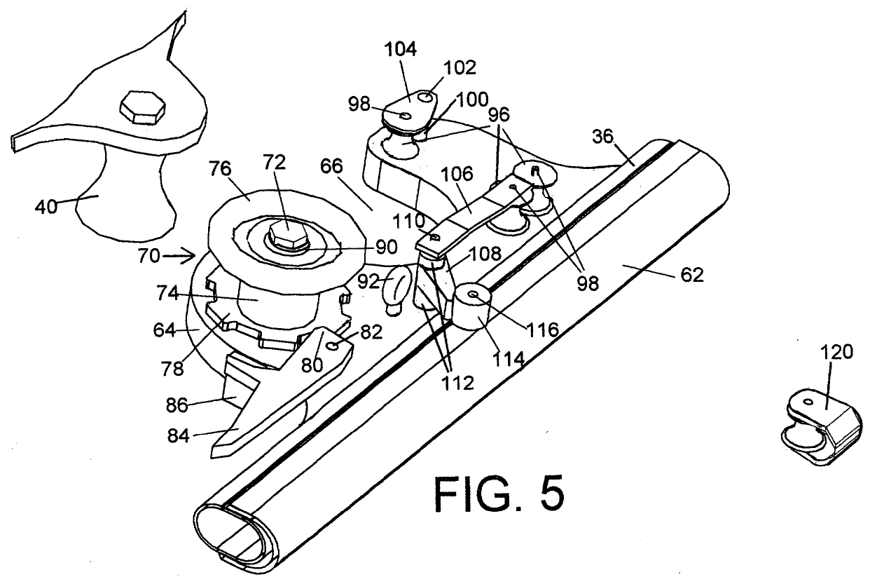

FIG. 5 is a partial isometric view of the preferred embodiment of the 4-line harness release.

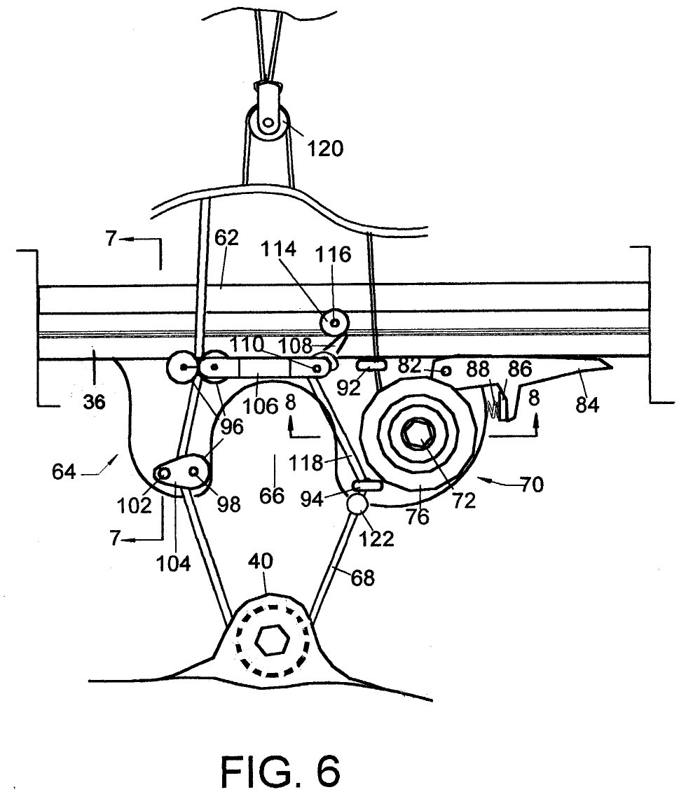

FIG. 6 is a partial plan view of the preferred embodiment.

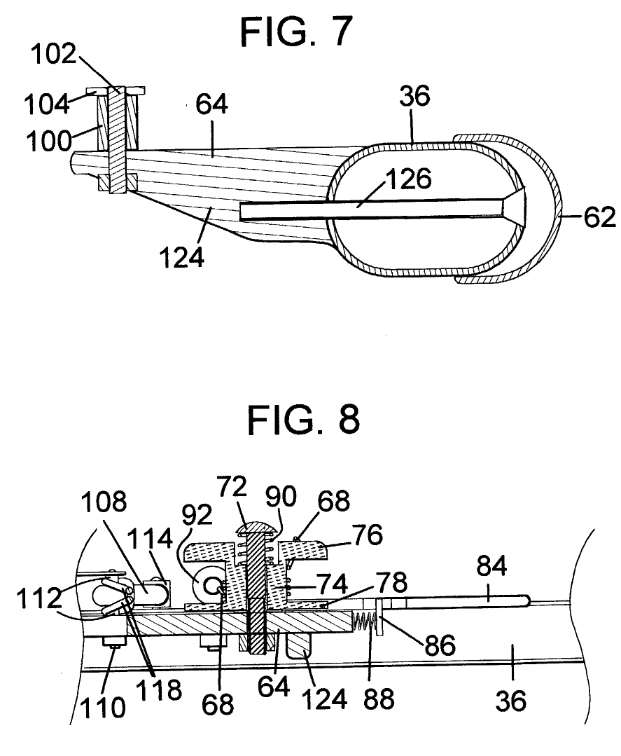

FIG. 7 is a transverse sectional view of the preferred embodiment, showing the section 7-7 from FIG. 6.

FIG. 8 is a longitudinal partial sectional view of the section 8-8 from FIG. 6.

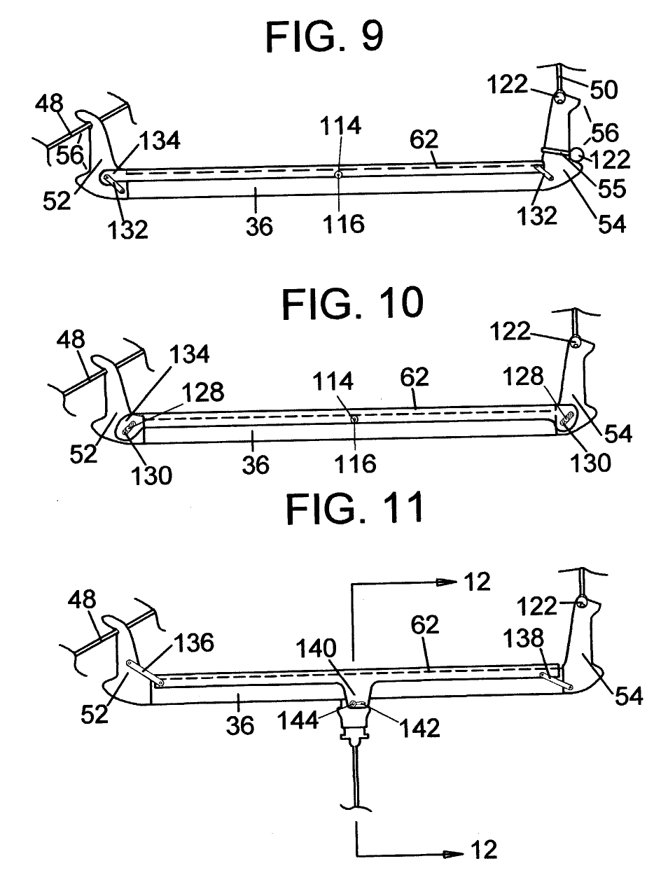

FIG. 9 is a plan view showing a control bar with parallel strapguided suspension of the sensor sleeve.

FIG. 10 is a plan view showing a control bar with pin-in-grooves as mounting for the sensor sleeve.

FIG. 11 is a plan view showing a control bar with a swing-away strap-guided mounting for the sensor sleeve.

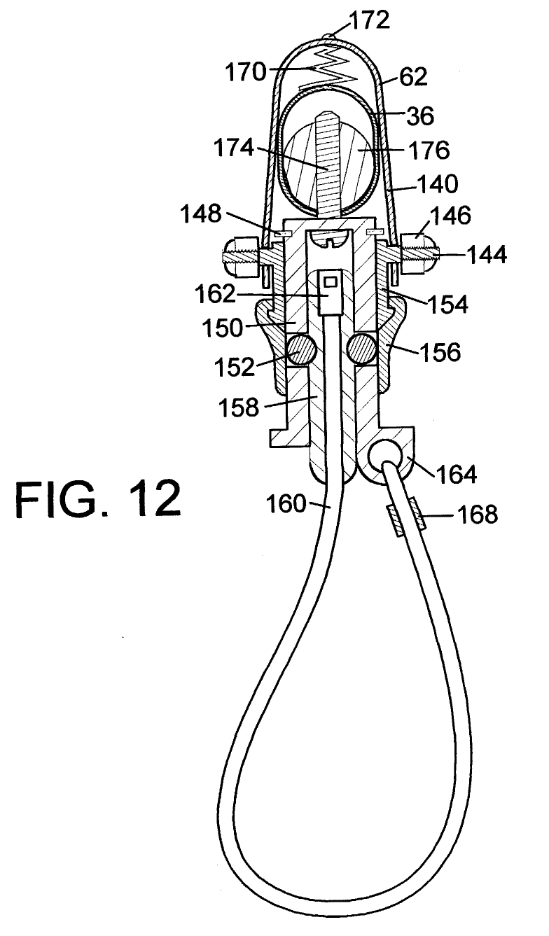

FIG. 12 is a sectional view of section 12-12 from FIG. 11, with a swiveling harness attachment.

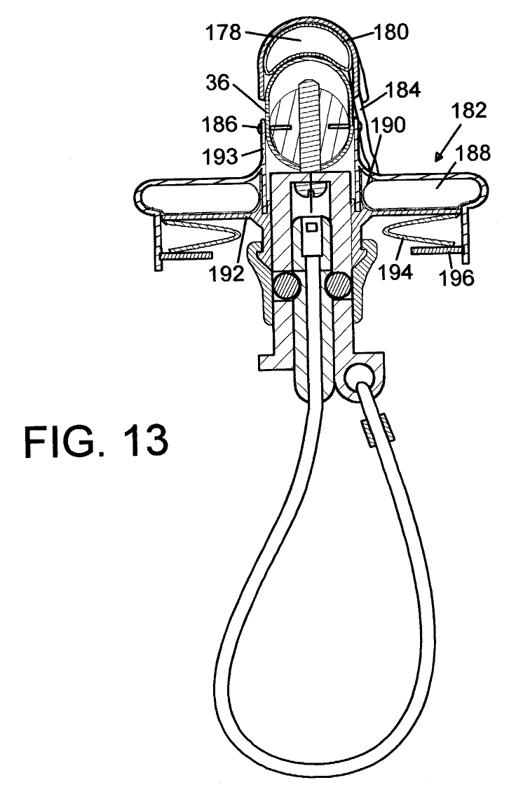

FIG. 13 is a sectional view of a fluid-actuated alternative to the mechanical device shown in FIG. 12.

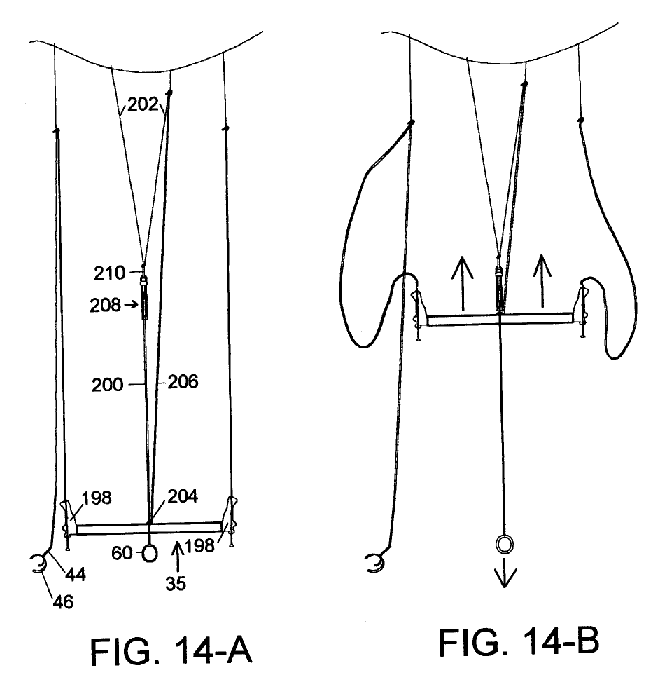

FIG. 14-A is a plan view of the control bar and kite lines with a line-mounted release device, and a separate elastic cord attached to one of the front lines.

FIG. 14-B is a plan view of the effect of a rider releasing the control bar, while attached to the harness line, shown immediately before disconnection of the leader and loop.

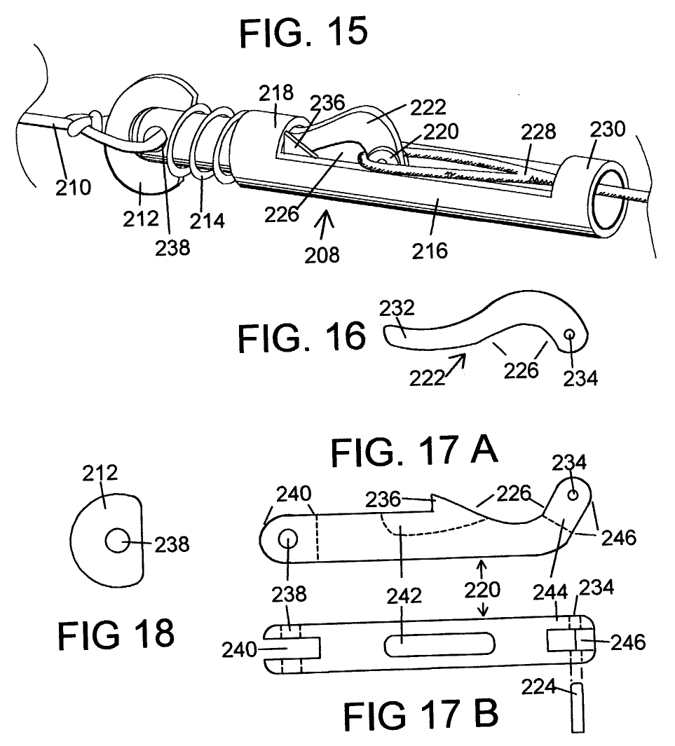

FIG. 15 is an isometric view of the preferred embodiment of a line-mounted release.

FIG. 16 is a side view of the release hook from the assembly shown in FIG. 15.

FIG. 17A and B are side and top views of the main body of release device shown in FIG. 15.

FIG. 18 is a side view of the spring-retainer insert shown in FIG. 15.

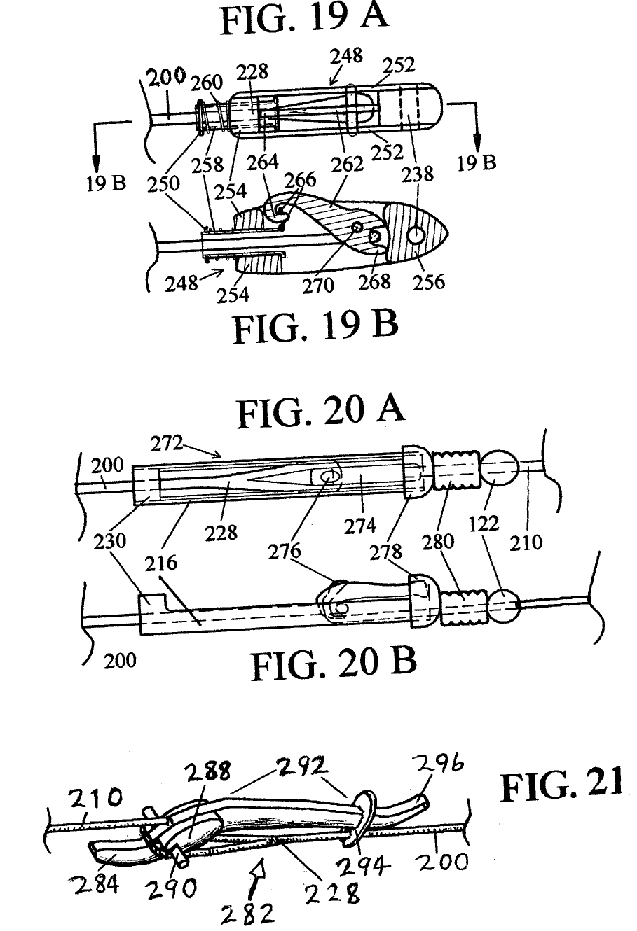

FIG. 19A and B are top and section views of an alternative type of line-mounted release.

FIG. 20A and B are top and side views of another alternative line-mounted release.

FIG. 21 is an isometric view of an alternative type of line-mounted release device

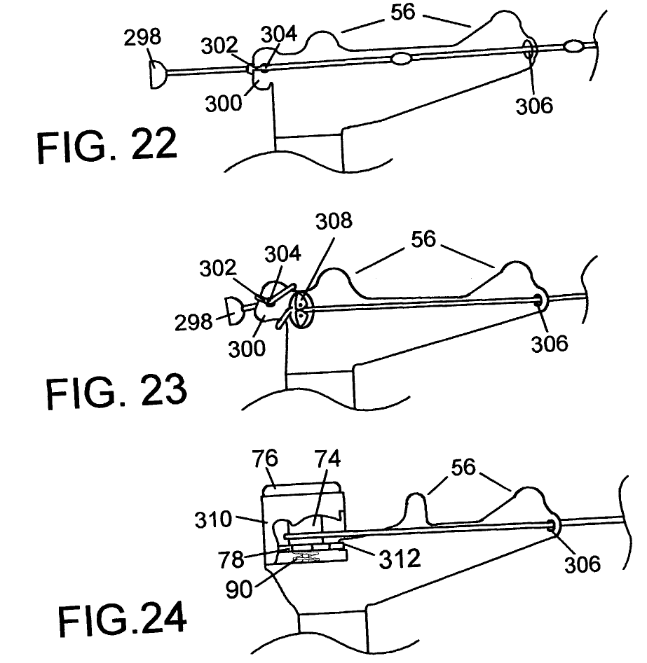

FIG. 22 is a partial plan view of a control bar with a knot type adjustment used in FIG. 14.

FIG. 23 is a partial plan view of a cam-cleat adjustment alternative to FIG. 22.

FIG. 24 is a partial plan view of a locking reel adjustment alternative to FIG. 22.

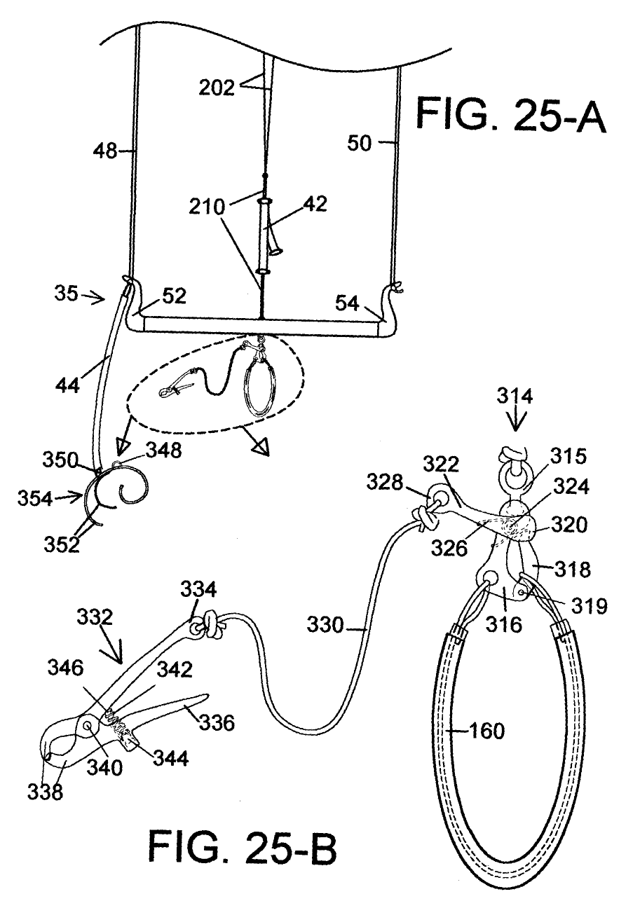

FIGS. 25A and B are plan views. 25-B is a magnified view of the swiveling pull release.

### DETAILED DESCRIPTION OF THE INVENTION

The Preferred Embodiment

FIG. 5 shows ratchet reel 70, which consists of adjustment wheel 76, contiguous with winding cylinder 74, and said cylinder likewise continuous with cogwheel 78. Further parts of reel 70 include release lever 84, positioned in front and to the right of cogwheel 78, pivotably secured to plate 64 by pin 82. It is positioned so that ratchet pawl 80 may be disengaged from cogwheel 78, allowing reel assembly to turn on bolt 72, which is bolted to plate 64.

FIG. 6 shows how offset plate 86, contiguous with lever 84, compresses ratchet spring 88, so that lever 84 returns to engage pawl 80 in cogwheel when released. Lever 84 is positioned close to handle 36, so that it is not likely to be accidentally pulled or to entrap loose straps or ropes.

Path of Harness Line and Associated Parts Description

Harness line 68 is fixed to ratchet reel 70 by passing through a hole onto top surface of wheel 76 or elsewhere, and being knotted or tied to prevent its being lost when reel unwinds fully, or from slipping around winding cylinder 74 without winding. Said line then passes forward through line guide 92, a polished stainless or low friction plastic material with a large enough bore and rounded contact area to prevent binding and minimize friction with line.

Line guide 92 is to prevent line from being pulled off edge of wheel 76, to assure the line does not pile up at one end of cylinder 74, and to direct the point of traction as far forward as possible to prevent bar 36 and attached parts from being rotated upward by traction of front lines. This occurs when roller 40 is disengaged and rider resists traction only with his grip on control bar 36. In future designs, a cantilever projection of guide 92 to a point forward of sensor 62 may be implemented For the same reason, a more forward point of line guidance for the left side is possible although a sufficient forward projection of only one guide, preferably guide 92, which does not slide on the line during riding, is adequate to prevent rotation.

As harness line 68 passes through pulley 120, which is attached to short leader rope 210, or directly to front lines 202, it receives traction from said front lines. Said line then passes between paired front guide rollers 96, and between rear guide roller 96 and cylindrical standoff 100. Said guide rollers are secured to plate 64 by roller axles 98. Rollers 96 are concave on their rope-contact surface to accommodate rope diameter without resistance when placed so the edges of each roller are almost in contact with those of the opposite roller, thus preventing escape of harness line 68. The use of an identical roller on the rear assembly prevents rope chafing.

Roller axles 98 all may be constituted by a smooth-shank bolt or machine screw, with a threaded end for engagement into plate 64. Similar to said axles 98 is guide shaft 102, except that it need not have as large a diameter, as lateral stress on the rear assembly is mostly toward the center, especially when rider is un-hooked. Said shaft, surrounded by said standoff, is positioned close enough to rearward roller 96 that a knot in harness line 68 will not pass through between them. Knot-stop cover plate 104 serves to prevent line 68 from escaping out the top, being connected between axle 98 and shaft 102.

After passing between rearward roller 96 and stand-off 100, harness line 68, when not engaged in roller 40 and pulled to variable distances rearward by rider, will span hooking recess 66 under tension from front lines 202. Said recess provides an opening where rider can pass roller 40 in front of harness line 68 to engage it and pull it rearward, thus “hooking in” to ride in the harness. A knot or stop knob 122 (usually held in position by a knot) is placed in line 68 in a position such that, when said line is engaged in the release, said knob will lie adjacent and rearward of rope guide 94. Said harness line then passes forward, where it is formed into a small loop 118.

Said loop is large enough to easily encircle release cam 108, but small enough that it cannot accidentally ensnare roller 40 when released and passing around behind it. Said release cam is of a length, position relative to cam stop bushing 114, and shape to provide correct amount of forward force to function optimally. Loop 118 passes under anti-fouling cover plate 106 to encircle release cam 108, and passes around spacers 112 (visible in FIGS. 5 and 8), which maintain central position of cam 108 on cam axle 110. Cam 108 is swung forward and clockwise after loop 118 is passed over it, and engaged behind cam stop bushing 114. Said bushing is secured to edge of sensor 62 by stop bushing rivet 116, which allows rotation of bushing. When sensor 62 is gripped anywhere along its length, it is maintained in the rearward position, snugly against control bar 36. Said anti-fouling plate is to prevent accidental and careless passing of loop 118 over the top of cam axle 110, thus snaring it so that release would not occur.

Operation of Release

When there is no kite traction on front lines, and thus on harness line 68, the sensor may be released without movement. This prevents accidental release when kite 32 is not flying, or exerting traction. When traction is significant on front lines, harness line 68 pulls against cam 108 with sufficient force to push cam stop bushing 114, and thus sensor 62 forward The resulting clearance between bushing 114 and cam 108 allow said cam to swing freely counterclockwise until loop 118 slips off cam 108, out of rope guide 94, around roller 40, and then further rope movement is prevented by knot or stop knob 122 striking rearward pulley 96, plate 104, and/or standoff 100. Thus, after release, harness line 68 is not lost from control bar, and rider may easily re-attach it by passing loop through rope guide 94 and around release cam 108, and locking said cam behind cam stop bushing 114 by gripping handle 36 and sensor 62, closing them together.

Reel 70 may also be adjusted incrementally for power adjustments by lifting on and gripping wheel 76 with fingers of right hand while pressing on head of bolt 72 with thumb for counter-force, and turning wheel. Ratchet pawl 80 is prevented from springing under cogwheel 78 by stoppage of return action by lever 84 striking bar 36. In this mode, ratchet pawl acts as a stationary lug. When wheel 76 is released, reel spring 90 forces reel downward until cogwheel 78 is against plate 64, and ratchet pawl 80 is re-engaged in cogwheel 78.

Sectional Views

Referring now to FIG. 7, control bar 36 provides the mounting for sensor bar 62, and on the opposite side, for mounting plate 64, upon which are mounted the previously described parts of this embodiment. Plate 64 consists of a flat top surface with a plurality of reinforcing struts 124 on the bottom surface. Said struts are contoured to closely fit control bar 36 on their forward end. They project rearward far enough to provide sufficient grip for threads of bolts 126, when same are used, and to provide rigidity to plate 64 to allow minimum thickness material to be used. In the molded shape, cross bracing struts can further tighten this plate.

In FIG. 8, a longitudinal section through ratchet reel 70 assembly, harness line 68 is shown cut by the section as it winds around winding cylinder 74. It is also shown cut after bifurcating into two branches to form small loop 118. Said loop may be seen encircling cam 108, after passing to the left of spacers 112, surrounding cam axle 110. It may be noted here that small diameter kite line 68 is wound onto reel 70, after passing through pulley 120, but the diameter of loop 118 rope is much larger. This is because larger diameter rope is used for the portion of line 68 which is actually engaged by roller 40, but a smaller diameter is desired to reduce crowding on winding cylinder 70. The different diameters may be joined by a knot just past the range of movement of control bar 36.

Cam stop bushing 114 is mostly obscured by release cam 108, but may be seen. Rope guide 92, in this embodiment a stainless eye-bolt, may be seen partially obscured by winding cylinder 74. Axle 72, in this embodiment a stainless pan-head bolt, is secured by a nut, or may be threaded into a stainless or brass insert in the injection molded embodiment, as may all other shafts or pins. Stainless reel spring 90 may be seen to provide force to maintain reel in contact with mounting plate 64. Continuity of material in adjustment wheel 76, winding cylinder 74, and cogwheel 78 may be clearly seen.

A smaller stainless expansion spring, ratchet spring 88, may be clearly seen as it presses offset plate 86 to the right, resulting in ratchet lever 84 pressing against control bar 36. Also visible is cut end of strut 124.

Construction

Plate 64 may be injection molded from a variety of high-impact polymers, but prototypes or short runs are made from polycarbonate or a similar plastic. Polycarbonate struts 124 are cemented to the bottom surface with methylene-chloride solvent. These struts receive a plurality of bolts 126 which secure plate 64 to control bar 36. With injection molding, plate can be made much thinner and lighter, with thickened areas and/or brass inserts to provide secure anchorage for threaded shaft ends, or bolts. Alternate construction may be with epoxy-fiber (preferably carbon) composite, where plate 64 can be bonded directly to bar 36, when it is also made of composite.

Guide rollers 96 are made from machinable, lubricious rod stock, such as polyethylene, by lathe turning. Roller axles 96 are stock smooth-shank bolts or machine screws.

Where there is any possible penetration of control bar 36 by water, whatever the method of construction, it is important to prevent significant filling of said bar with water and thus loss of buoyancy by injecting the interior with self-catalyzing, expanding polyurethane foam. One widely available trade name of this foam is “Great Stuff”.

Sensor bar 62 is a half tube of aluminum or carbon fiber composite, with flattened sides, movably attached to control bar 36. Said bar also has flattened surfaces on opposite sides upon which slide the inside surfaces of sensor sides. Control bar may also be of thin-wall high strength aluminum alloy. As described above, it may instead be of carbon or glass fiber composite, which will enable bonding to mounting plate 64 without fasteners. A buoyant plastic such as expanded polyvinyl chloride is quite adequate in strength for entire reel assembly 70, as it provides additional buoyancy. The assembly may be machined from a thick single piece or multiple layers bonded together of expanded PVC plate stock.

Modifications of the Preferred Embodiment

Several configurations of the preferred embodiment are possible without changing the basic functioning. Others discussed below alter the function significantly.

One modified version of this device eliminates the entire reel 70, and pulley 120. This results in the front lines having a 2:1 mechanical advantage over the roller 40. When hooked in, the rider will have to push bar 36, rather than pull, with adjustments to the push for power control and steering. This 2:1 ratio gives rider the ability to cover the full range of power adjustment with no line adjustments at the control bar. This effect may be moderated by placing extension struts on kite tips. These extend forward of the normal front line attachment points, and are the revised attachment points for the front lines. This reduces some of the pull on the front lines, adding it to the rear lines, and reduces the 2:1 ratio. It allows the rider to approach a neutral feeling of the bar when hooked in. The above embodiments are for 3 or 4-line kites, where the front lines are attached to the harness.

For 2 line control bars, one modification of this device eliminates the entire ratchet reel 70 assembly, guide 92, guide rollers 96, roller axles 98, plate 104, and most of the mounting plate 64, except for a small remnant sufficient to mount a release cam 108, spacers 112, cam axle 110, anti-fouling plate 106, standoff 100, and guide shaft 102. Said standoff and shaft are located in the place of one guide roller 96 to support end of plate 106. A short length of rope with a loop on one end is used as the fixed type harness, but while one end is fixed to plate 104, as through a drilled hole, the other looped end is attached to release cam 108. As the desired amount of rope may be draped as a loop, no rearward projections of plate 64 to create hooking recess 66 is needed. When unhooked, the loop merely hangs loosely, as it is not pulled tight by front lines.

Many other modifications of the preferred embodiment are possible. The most extreme simplification is possible for 2-line control bars. By elimination of the entire plate 64 and all attached parts, only the sensor 62 is retained, and this without cam stop bushing 114 and rivet 116. One end of the fixed type harness similar to that in FIG. 3 may be attached to control bar 36 by passing it once around and tying a knot. The other end, with a simple half-hitch or figure 8 knot, is wrapped once around bar 36 and trapped under edge of sensor 62. Traction on line 68 furnishes forward force on said sensor to be resisted by grip. When grip is released, sensor is forced forward by traction, releasing knot, and end of line is released, as is rider.

Control Bar End Fixture Alternatives—FIGS. 9-11

The requirement for the sensor strip 62 is that it move bodily forward or rearward, so that a grip at one end will not allow that end to be closed against control bar while leaving a gap in the middle, or toward the other end. This would allow the sensor strip to release by opening partially when loosely gripped at one end.

By suspending the sensor so that it moves bodily, a light gripping force anywhere along the bar will produce an equal closing force at any other point. The embodiments shown below, along with others not shown, will produce this effect satisfactorily. For the short range of movement required, the suspension methods below produce a parallelogram, or near-parallelogram in FIG. 11. All parts of the suspension shown on the top side control bar 36 of the plan views in FIGS. 9-11 are also duplicated on the bottom side of said bar.

FIG. 9 shows a true parallelogram produced by equal length straps. Pins securing straps 132 to control bar 36 need not penetrate the hollow portion of said bar, but may penetrate only the end members. This is because of extension tabs 134 of the flat portions (top and bottom of one end) of sensor 62. This places the movable left ends of attachment straps 132 far enough laterally that the fixed ends may be secured by a common pin (not referenced) through the bar end fixture 52, rather than through the hollow portion of control bar 36. This embodiment uses pivots secured by common rivets (not referenced) in the movable ends of straps 132, and said common pins in the non-movable ends.

In this embodiment, the line winder spaces 56 and the release disabling device consisting of elastic cord 55 and stop knot or knob 122 are shown, but they are likewise present, though not depicted on the following two figures.

Also shown is the sliding-line end fixture used with the type of kite leash shown in FIG. 3 of prior art. This type of leash arrangement may be used with any of the embodiments employing a sensor 62. This and other leash arrangements were discussed under prior art, but are shown again here for a larger view.

The sensor 62, straps 132 on each end, and control bar 36 form a parallelogram with a pivot at all 4 apices so that all opposite members remain parallel despite changes in angle of the apices. This results in a slightly arcing, but generally oblique bodily movement of the sensor 62 through the small amount of angular movement relative to the length of straps 132. The angle of straps 132 when sensor 62 is closed against bar 36 is pre-set, so that the initial 10-15 degrees of arc produces a movement of about 45 degrees to the right of a perpendicular line from bar 36. Further movement is not needed, and is limited by sensor 62 striking end. fixture 54.

FIG. 10 embodiment also produces a true parallel bodily movement of sensor 62, by allowing guide pins 128 to slide within grooves 130. When extension tabs 134 of sensor 62 are employed on both ends, guide pins may be located on the end fixtures as are the above common (pivot) pins.

FIG. 11 embodiment produces slightly less parallel (bodily) motion of sensor 62. As in FIG. 9, sensor is mounted on pivoting straps, secured at both ends by common fittings, but these are arranged in a non-parallel configuration. Longer non-parallel straps 136 are placed at the left end of bar 36, and shorter straps 138 at the right end, to achieve oblique motion to the right of sensor 62.

Extension tabs 140 on top and bottom of control bar 36 are extensions of flat portions of sensor 62. They are penetrated by operating rod slots 142, in which ride operating rods 144. The elongation of said rod slots allows for the lateral component of motion in the sensor 62 as it moves forward and to the side when released. Because the assembly shown in FIG. 12 is rotatably fixed to bar 36, it cannot move laterally, so the points of connection must allow for lateral relative motion of sensor 62.

Mechanical Release—Description

FIG. 12 shows cross section 12-12 of FIG. 11. This device can be used with any of the sensor suspension configurations shown in FIG. 9-11, or with others not shown. Forward force on sensor 62 is produced by one or more stainless, helical, flat or round cross-section springs 170, held in place by a central rivet 172. Said spring or springs are distributed symmetrically so that even force is applied to press sensor 62 forward Spring 170 is formed so that when fully compressed, coil lies in a planar spiral (in this case conforming to the curvature of space between sensor 62 and bar 36 when closed to solid height of spring). Forward motion of said sensor by said springs is limited by external snap ring 148 in a groove on the proximal end of main body 150.

Release operating tabs 140 are shown in section extending to and slightly beyond operating rods 144, which are stepped down in diameter and threaded to receive friction nuts 146. Smooth neck of said rods rides in slots 142 (shown only in FIG. 11) with said friction nuts prevented from impinging on said tabs by step. Said rods are contiguous with sliding collar 154, which slides longitudinally on main body of release 150. contiguous with sliding collar 154, which slides longitudinally on main body of release 150. At the opposite end of said collar a barbed ring is cut on the outer circumference. This retains an elastomeric collar 156, which covers a plurality of drilled holes disposed radially in said main body to restrain entrapped retaining balls 152. Holes are step-drilled, so that inner wall penetration is at a diameter slightly smaller than said balls. They will therefore fall only to the outside of said main body. A releaseable pin 158 slip-fits inside said main body. It is radially grooved at a location corresponding to the location of holes when almost fully seated, with some clearance between swaged cable lug 162 and head of machine screw 174. Said screw retains main body 150 against common plastic spacer (not shown) between said body and control bar 36, but allows rotation of said body about axis of said screw. Screw 174 threads into a plastic insert 176 inside bar 36 to retain it in place.

Harness cable 160 is retained inside said pin by a swaged cable lug 162, on one end The other end is secured to attachment eye 164 by a loop in the end secured by crimped sleeve 168.

Function

When sliding collar 154 is in retracted position as shown in this view, balls 152 are lightly held in position by an elastomeric collar 156. This prevents outward loss of said balls, and also prevents dislodgement of pin 158 unless significant tension is applied to cable 160 to overcome resistance. When bar 36 is grasped, sensor 62 compresses spring(s) 170 and closes toward said bar, moving release operating tabs 140 rearward (downward in the view) and likewise operating rods 144 and sliding collar 154. This locks retaining balls 152 into radial groove in releaseable pin 158, preventing its release. A release of all grip on bar 36 reverses all above motions and allows release of said pin, and embedded harness cable 160. Cable then releases rider from harness, but is retained by attachment eye 168.

Fluid-Activated Release—Description

FIG. 13 shows another embodiment, in cross sectional view as before, and represented by, but not depicted in the section 12-12 in plan view of FIG. 11. This device fits on the control bar in the same position as the previous device. A fluid, such as air, is used to transmit force required to maintain fixation of harness cable 160 in position. In many parts, the device is similar or identical to the mechanical embodiment shown in FIG. 12. Differences are as follows: Space between control bar 36 and sensor 62 is occupied by sensor bladder wall 180 surrounding sensor chamber 178, which communicates via fluid passage tube 184 with diaphragm chamber 188. Said diaphragm chamber is lined by diaphragm bladder wall 190. Instead of being integral with operating rods 144, as in the mechanical embodiment, sliding collar is integral around its entire circumference with sliding collar plate 192, which serves as the expanding wall of diaphragm 182. The passive position of the sensor 62 is forward, and away from bar 36. This position is maintained by return spring 194, which is, in effect a double conical spring with the smaller diameters in apposition, and integral. Radial slits from periphery toward center through both cones weaken spring to the required degree for the correct return force. Internal snap ring 196 maintains said spring in position, and under some compression at all times. Diaphragm 182 would be free to rotate, but would sever line 184 in doing so. Thus is it prevented from rotation by extension arms 193, which extend up to just short of travel range of sensor 62, and are fixed in position by retaining screws or pins 186.

Function

While grip is maintained on sensor 62, sensor chamber 178 is compressed, forcing fluid to remain, under increased pressure, largely evacuated from said chamber and forced to reside in diaphragm chamber 188. When grip is released, return spring 194, being under increased compression due to expanded volume of chamber 188, is able to expand, forcing sliding collar plate 192 forward (upward in view), and forcing fluid out of said chamber and through tube 184 into chamber 178, now with lowered pressure. This actuates release as sliding collar 154 moves forward, releasing balls 152 to move outward, releasing pin 158 with encased harness cable 160, releasing rider from harness.

The advantage of both the mechanical and the fluid-actuated devices over the preferred embodiment, which may be used on 2 line kites as well as 4 line, is that these devices allow the advanced rider to spin the bar to remove twists in the kite lines. A kite leash cannot be worn if the rider intends to spin the bar.

A disadvantage is the greater difficulty of manufacture, as there are more complex parts. Diaphragm 182 may be made from injection or blow-molded plastics. Bladders 180 and 190 may be made from heat-sealed polyurethane sheet, the heat-seal element being formed to the desired outline. A hard, high strength injection moldable plastic can be used for all rigid parts. Rather than a stainless cable, a polyaramid or nylon rope could be used. Cable lug 162 is shown as a swaged lug, but if rope were used, the entire length of pin 158 could be used for embedment bonding, with a flare at the end, rather than a swaged lug. Some thickening of the design of the eyelet 164, would be required. If metal were used, the parts as shown should be scaled down, as they would be heavy and much stronger than needed, especially for stainless steel.

Line-Mounted Release Devices

FIG. 14-A is a plan view of the general layout of line-mounted releases. Instead of a sensor 62 on control bar 36, a prior-art type control bar 35 may be used. The invention in this embodiment consists of two components:

(1) a release device 208 mounted on the front lines leader rope 200 which will release the rider from attachment to the kite when bar 35 is released.

(2) a means to assure that control bar 35 will retract far enough to strike the release device 208 when dropped from rider's grasp.

Addressing the second component above, at least 3 methods will achieve this requirement. The simplest is shown in FIG. 14-A as a simple elastic (bungee) cord 206 attached to control bar at, or as near as possible to the hole in bar, or eyelet 204 for passage of rope 200. The other end is attached to one of the front lines 202. Leader 200 must be of sufficient length that, when rider is extending his arms through the entire range of motion used in riding and jumping, eyelet or control bar will not reach release device. Thus, retraction means must be of sufficient length and elasticity to assure that bar will slide up leader line 200 past this point, and continue with enough velocity to strike and actuate release. A distance of 1.2 M (4 feet) from chicken loop 60 to release device 208 is sufficient for nearly all riders.

FIG. 14-B shows a plan view of the embodiment in 14-A after the bar has been released, and an instant before release of leader 200. The slack in the steering lines 48 and 50 is apparent.

The advantage of the embodiment shown in FIG. 14-A is its simplicity. However, the elastic cord produces a slight pull on one of the front lines 202. This results in a tendency for the kite to steer away from that side, rather than remaining stable overhead when control bar is level. This tendency may be eliminated by the use of two elastic cords of half the elastic tension of the previous one. These are attached to both front lines, so that the drifting tendency is eliminated. The disadvantage to this is the additional complexity of managing two additional lines, as well as in winding them on the bar.

The preferred embodiment of this line retraction means is one which may not be easily illustrated, but need not be. It consists of replacing steering lines 48 and 50 with light tubular nylon or polyaramid webbing, with a very light bungee cord inside it. A more desirable, but difficult process is to pass an elastic monofilament such as an extruded polyurethane cord through the core of a standard tubular woven leader rope.

Advantages and Disadvantages of the Line-Mounted Release Device

The principal advantage of this system is its simplicity and low cost to build One disadvantage is the relative difficulty of retrieving the “chicken loop” 60 and resetting the release device after it has been tripped. Using a floating, brightly colored material for said loop greatly reduces this problem. A total solution is to dispense with the chicken loop and secure the end of leader 200 to rider's harness 34 by means of a prior art quick release snap connector, so it will remain attached to the rider after actuation of release 208.

A second disadvantage is that it must be used with the older type kite leash shown in FIG. 4, where the leash 44 is attached at a distance up leader line 48. This is a somewhat more tangle-prone arrangement than that of FIG. 3. Last, there is the inability to adjust the leader rope 200 for power control, as with prior art strap adjustment 42. Said rope must be free after being released from line mounted release 208 to slide through and completely free of bar 35.

In FIGS. 15-21, there are 4 embodiments shown for the release device, although many others are possible. All the devices shown employ release of a loop on the forward end of leader rope 200. However, other devices could release a free ended rope, or a knot, or a special attachment. The advantages of a loop release are simplicity, reliability, and lower rope wear.

Special rope (or cable) ends, such as the pin 158 shown in FIGS. 12 and 13 also are reliable and low wear, but are more complex.

The Preferred Embodiment of the Line-Mounted Release Devices

FIGS. 15-18 show the preferred embodiment 208 of a line-attached release device. FIG. 15 is an isometric view showing the entire device 208. FIGS. 16-18 detail some of the parts which are not well shown in FIG. 15.

Front lines 202 (seen in FIG. 14-A) are attached to short leader rope 210, which tied to this device through hole 238. Said rope through said hole serves to maintain spring retainer insert in place within slot 240 of main body 220, while maintaining initial compression of expansion spring 214, as said spring holds window cylinder 216 in the rearward (locked) position. In this position, retainer ring 218, a portion of said window cylinder, covers end of hook retaining arm 232, preventing it from escaping upward and swinging to rear (right in this view). Stop tabs 236 prevent said cylinder and said retainer ring from being driven too far to rear, and jamming on slope of release hook 222.

Leader rope 200 passes through rope release eyelet 230 and then ends in a loop, joined at the free end in clean-sliding rope splice 228. Loop of rope is passed over arm 232, slid down hook 222 into rope engagement area 226. Said area allows hook 222 to be closed, arm 232 entering recess 242, without pinching rope against main body 220. Main body pin 224 passes through pin hole 234 in said main body and said hook, pivotably joining them together. Window area of cylinder 216 is long enough so that when spring 214 is fully compressed and hook 222 is swung 180 degrees to rear, arm 232 will clear eyelet 230 by a wide enough gap that looped rope 200 will readily escape off said hook and out of said eyelet.

Advantages and Construction

The embodiment 208 is extremely reliable, light, and very simple to manufacture. Window cylinder 216 may be easily cut from 16 mm (⅝″) O.D. PVC schedule 20 pipe. Release hook 222, insert 238, and main body 220 may be cut from 5 mm (3/16″) and 13 mm (½″) polycarbonate sheet, or a similar material. After milling slots and drilling holes, pins may be cut from stainless rod stock. Stock stainless expansion springs are used in all embodiments of this release device except for special spring shown in FIG. 18. Another alternative to springs is shown in FIG. 21. While not as resilient as stainless springs, the corrugated elastomeric tubing has the advantage of being much less prone to tangle with lines. It may be used in other embodiments of this device as well.

Alternative Line-Mounted Release Devices

FIGS. 19-21 show 3 other alternative embodiments.

First Alternative—FIGS. 19A and B

FIG. 19-A is a plan view and FIG. 19-B a section view taken from FIG. 19-A showing alternative line-mounted release 248. Said release is mostly enclosed by side walls 252, plunger retainer insert 254, and front insert 256. Leader rope 200 passes through plunger 258, and around harness release projection 268 of release lever 262. Said lever pivots on lever pivot pin 270 and is maintained in locked position by locking hook 264, which in turn is entrapped by perforated locking tab 266, integral with said plunger. Plunger is maintained in locked (left in this view) position by plunger retaining spring 260 expanding between external snap ring 250 and plunger retainer insert 254. Said plunger is prevented from exiting insert 254 by a flange, which is enlarged on one side to form said perforated locking tab. Release 248 is as reliable and problem free as the preferred embodiment above, but is somewhat more difficult to build.

Construction

Using 3.2 mm (⅛″) aluminum sheet stock for lever 262 allows a smaller device to be used, while not sacrificing strength. Polycarbonate 3.2 mm (⅛″) sheet forms sides 252 and 13 mm (½″) sheet forms both inserts. Heavy walled 9.5 mm (⅜″) O.D. aluminum tubing forms the plunger, and stainless stock snap rings and expansion springs are employed. Pin 270 is cut from 4 mm (5/32″) stainless rod Plunger 258 is grooved, then flange is formed with a pre-cut long strip or extension on one side, which after forming will be flattened and lie at 90 degrees to main tube. It may be punched in the same or a subsequent operation to form the hole for locking hook 264. Insert 254 is drilled to 0.1 mm (0.003-0.005″) over the diameter of said plunger, which is then inserted. Aligning locking tab toward top, both inserts are then bonded to side walls 252. Side walls are drilled to a press fit, while lever 262 is drilled to a slip fit.

Second Alternative—FIG.20-A

Alternative release 272 is shown in plan view. Sectional view 20-B is taken from a section indicated in plan view. In this device short leader rope 210 from leader lines 202 presents first a knot or stop knob 122, then passes through expansion spring or corrugated tube 280, then through a slip-fit hole in retainer cap 278, and terminates in an embedded end 276 in release hook 274. Said hook, when encircled by loop of leader rope 200 and locked, somewhat resembles hook 222, with the free end locked under a lip of window tube 216, identical to the previous embodiment. In this embodiment, however, plastic pipe cap 278 is added to prevent loss of said hook out front (right) end of tube. All remaining components to the rear (left) end of said tube are identical. Construction of the remaining components is as described above. Release 272 is easier to build than the preferred embodiment 208, but somewhat less foolproof in operation.

Third Alternative—FIG. 21

Third alternative release 282 is shown in isometric view. Like the preceding device, short leader rope 210 is embedded directly in release hook, which is a much longer body in this device. A thickened embedment area 288 where release 282 must be drilled to accommodate rope for embedment prevents weakening so that thinner material may be used in all other areas. Harness line release arm 284 is directed forward (left) engaging loop of leader rope 200. A middle section release 282 is resistance arm 292, the length of which determines the mechanical advantage. This is a ratio of length of the lever arm resisting release292, to the lever arm causing the release. The latter is the short distance (roughly 6 mm or ¼″) between the mean points of traction between ropes 200 and 210 in the locked position. The longer the resistance arm 292, the less the dislodgement force on elastomeric rope clip 294. Disengagement projection 296 curves away from rope 200, so that when it is struck by control bar 35 or its eyelet 204, it will be deflected away from the taut rope, pulling clip 294 loose, and allowing main body of 282 to swing forward while hook 284 swings rearward, releasing loop of rope 200. Anti-fouling pin 290 penetrates body of release at point of loop encirclement. Said pin prevents loop from slipping off thickened area 288 and encircling rope 210, thus preventing release. This is the same type of entrapment referred to in the preceding device description. It cannot occur if pin 290 is longer than loop can pass over when attached to hook 284.

Construction

Release 282 is simplest to build, being a single piece of plastic with an added elastomeric rope clip 292 and pin 290. It may be made from one piece of 12.7 mm (½″) or 9.5 mm (⅜″) stock, or from thinner pieces with reinforcement plates bonded to area 288. Rope is embedded in both this and the above device by drilling a snug slip-fit hole in the desired location, with a counter-drilled taper on side where rope end will lie. Rope is passed through, end fluffed, then impregnated with epoxy or polyester resin and pulled back until fluffed end lies flush with surface. When resin cures, rope is locked in place. Pin 290 should be long enough that loop of rope 200 cannot pass over either end to ensnare rope 210.

Disadvantages to this release are that it is less reliable, requiring often more force to open and release loop dependably, and it has more projections to tangle with other lines.

Steering Line Adjustment Devices—FIGS. 22-24

With line-mounted release device, there must be no line-length adjustment device 42 between the control bar 36 and the release device 208, so that the line attached to the rider may slide freely through and free of the control bar after release. Another means is provided to adjust relative line length for the comfort range of the rider. This is provided by an adjustment of each rear line at the ends of bar 36 by which length of front lines 202 relative to rear lines 48 and 50 may be manually set by the rider. A sidebenefit of this type of adjustment is the ability to readily adjust discrepancies in line length of said rear (steering) lines from the control bar. When the rider finds the kite requires constantly pulling one end of the bar more than the other, the line may be quickly adjusted to relieve this problem.

Knots-In-Slot-Retained Devices—FIG. 22

This is the simplest adjustment device. Grip knob 298 is for resisting pull of the kite when making adjustments. Steering line leader rope 48 (or 50, on opposite end) is gripped by said knob, and pulled out of rope friction slot 302, and adjusted by pulling the knots or stop knobs through rope guide eyelet 306, large enough in this embodiment to allow such knobs to pass through. When correct adjustment is made, closest knot to hole 304 is brought behind friction slot 302, and secured behind said hole. Excess line is then wound around line winder knobs 300, and secured by jamming rope in said friction slot.

The advantage of this device is simplicity of construction. Control bar end fixtures are cut from polycarbonate or similar plastic, heat bent, drilled, and shaped for insertion into bar ends.

The disadvantages are that it is more difficult to use than the embodiments which follow, and adjustment increments are controlled by knot or knob spacing.

FIG. 23 shows a similar arrangement where lines are adjusted by gripping knobs 298, and where excess is similarly wound, but here a set of marine cam cleats 308 have been installed, so the adjustment increments are not predetermined, and no knots or stops are required. Cam cleats 308 can engage rope by a cam-clinching action, so that rope can be pulled through rearward, but will not pull through forward To release more rope, a rearward and upward pull is necessary. The rope is adjusted above the cleats to the desired length, before being re-engaged by again pulling downward and rearward Cam cleats are a standard marine supply item, and small ones may be quickly installed with machine screws. This is a novel use of cam cleats in the present release device.

FIG. 24 shows the most complex embodiment. Reel parts are identical with those used in FIG. 5, except the ratchet lever 84 and associated parts has been deleted. Reel spring 90 has been placed under reel 70, rather than on top of it. In place of ratchet pawl 80 locking cogwheel 78, lug 312 performs this function. Spring 90 maintains reel 70 in upward position against head of bolt (axle) 72. To adjust, user presses inward on wheel 76 with palm of hand, allowing head of said bolt to intrude slightly on center of palm. Cogwheel 78 will then compress spring 90, and move into open area below locking lug 312 where it may be turned freely. Line is wound or unwound from winding cylinder 74.

A fairing 310 has been added to minimize tangling with other lines, as no need exists to grasp wheel 76 to pull outward in this embodiment.

It has the advantage of allowing the rider to adjust the lines by pressing lightly inward on wheel 76 to release the reel, then winding or unwinding without concern for excess rope left to dangle or be wound after adjustment. It also allows the rider to more easily steer the kite while making an adjustment. One reel is wound in one direction; the opposite reel is wound in the other. In order to reel both lines in or out together, user can place both palms over respective wheels 70, and twist in opposite directions, thus balancing torque exerted on control bar.

Construction of the above embodiment is identical to that of reel 70 used in the preferred embodiment, with the addition of a thin plastic cover, and fairing 310 and placing reel spring 90 above said reel. End fixtures are cut as shown in FIG. 24, drilled and tapped to receive axle 72. Fairing is formed from thin, large diameter tubing, of a bondable plastic, to which bottom may be added and bonded to tube, or it may be a pre-formed cup. Axle and spring will hold fairing in place by center-drilled bottom piece, and slot will self-align with leader line. Sides must be short enough that they will not interfere with hands while compressing adjustment wheels.

Pull-Line Release Device

FIG. 25-A is a plan view of the swiveling pull-release device 314 with associated prior art devices, showing how it replaces only chicken loop 60, and wrist attachment 46. All other components are prior art as shown in FIG. 4. This invention will work with both 4-line and 2-line kite control bars of the prior art. The fixed harness line 58 of prior art shown in FIG. 3 is replaced by this invention in the 2-line version, with a short rope tie or other fastener used to secure ring 315 to the center of the bar.

Kit leash cuff 354 is very similar to prior art wrist attachment 46, with the addition of a cord loop or separate attachment ring, the slip-clip ring 348, approximately 50 mm (2″) from the kite leash attachment point. This places it near the medial side of the wrist when the kite leash is attached to the lateral side, making it convenient to easily attach slip clip 332. Sandwich type hook and loop fastener straps 352 provide secure attachment.

FIG. 25-B is a magnified plan view of the remaining parts (except for the addition of a separate attachment ring to wrist cuff 354) of the present invention. The slip clip 332 is enlarged disproportionately (about 3:1) to show detail.

Slip clip 332 is composed of beaked crossover jaws 338, capable of clasping a steel loop, or polymer cord or rope, but not capable of separately hooking, as the angle of inner surface of each jaw is obtuse. Said jaws are close fitting and slightly overlapped to prevent rope or line under tension from being pulled into a crevice between them, as this weakens line. Clip pin 340 joins the opposite members of said clip together in a pivoting joint.

Opener lever 336 is embossed near this joint with a widened, thickened portion into which a stepped hole and threads have been placed. The threaded portion is fitted with a socket headed adjustment setscrew 344. Said setscrew abuts a small diameter heavy coil spring 342, which extends out of the larger hole on the inner surface of lever 336, across the gap between members, and is held by a spring retention lug 346 projecting from inner surface of opposite member. Opposite member terminates in a slip clip eye 334, for attachment of a small rope or cord 330.

Rip cord 330 connects by a knot to said eye, and the other end attaches similarly to cord eye 328, on the end of pull arm 322 of swiveling pull release 314. Pull arm is pivotally mounted to release body by release body pin 324. On the opposite, much shorter end of said arm is retention pawl 320, which is shaped to produce an interface with its articulating mate, release arm 318, such that no opening or closing force is produced by said interface when high traction force is applied. Arm 318 is flattened on the pivoting end where it fits into a slot between arms of release body 316. These are joined by release arm pin 319, fitted for free movement of arm 318. The forward (upward in view) end of release body 314 is formed by a ball-in-socket fitting, with the ball entrapped in said release body, and connected by a short shank to a swivel ring 315, which is attached to leader rope to front lines 210, or to a short rope attached to control handle 35.

Harness cable 160 is permanently fixed to a hole in release body 316, as it was to the devices in FIGS. 12 & 13, by a crimpled sleeve 168, retaining the free end of a loop through said hole. The opposite end of said cable is also formed into a loop in the same manner. This loop is passed over arm 318, which is then locked under pawl 320 when release 314 is loaded.

Torsion spring 326 around an embossed hub surrounding pin 324 provides force to keep pawl 320 in the locked position, unless a stronger pull on cord 330 opens it.

Operation

Users may adjust length of rip cord 330 and tightness of adjustment screw 344 in slip clip 332 to suit preferences.

When rider is finished with preparation of lines, and has launched kite, and hooked into harness, while flying kite overhead using left hand on control bar 35 and harness for control he then should attach rip cord 330 to wrist cuff 354, by squeezing levers of slip clip 332 together, and attaching it to slip clip ring 348 with the free right hand.

Upon falling, a movement of the left arm away from the bar, as when the bar is released, will pull rip cord 330, releasing one end of harness, thus un-hooking rider. Cable remains with release 314 and bar 35. Rip cord pulls hard enough to pull jaws 338 of slip clip 332 loose from ring, and leash remains attached, if used, to rider's wrist by the other ring. Rip cord and slip clip stay with control bar

Advantages

If rider is riding without harness, and performing spins in aerial maneuvers, he may untwist kite lines by spinning bar 35, without detaching from harness release or being unhooked, provided he keeps wrist close to bar to prevent pulling on lever 322. This may be done with either 2-, 3-, or 4-line control bars.

This embodiment is very light, simple, and easy to use. It requires rider to attach rip cord to wrist cuff after maneuvering to get board into position. The cuffed wrist must not be taken very far from control bar, as is sometimes needed when trying to get ready. No retraction elastic, adjustment reels, or old type kite leash need be used. The device is very easy to re-set after a fall. Even with the rip cord rather long, during a violent dragging, the arms will usually flail about, which would activate the release without deliberate action.

Said slip clip is advantageous over prior art because: 1) It is designed to slip off, not lock on, as with most snap hooks. 2) It is adjustable so the slip-off pull required may be tested and ajdusted as needed.

Said swiveling pull release is advantageous over the prior art because: 1) It is not sensitive to the direction of pull, as are some pull-release devices. 2) It provides an integral anchoring eye in release body 316 for the fixed end of harness cable 160 so the harness can swivel freely in relation to the control bar.

I claim:

1. A device for disconnecting a person from a traction kite harness which requires no action from said person other than the release of said person's grip on the kite control handle comprising:
a. a graspable handle or control bar portion,
b. a harness, attaching said person to said traction kite, and
c. a device which will release said person from said harness when grasp is released from said handle.

2. The device of claim 1 having a mounting fixture attached to control bar, which provides a mounting for line guides, reel, and release device; and a pair of projections with a void between them into which a spreader bar roller may be introduced, when pulled tight by kite traction.

3. The device of claim 1 having a cam-type release lever, which is prevented from rotating to release a loop, attaching one end of a harness line by a sensor strip or bar which is held in place by grip pressure.

4. The device of claim 1 wherein a locking reel with a releasing means is provided for collecting and containing several feet of the de-powering set of lines of a traction kite under tension, then releasing them to facilitate re-launching of said kite and for adjusting length of said lines for rider's preferred traction force.

5. The device of claim 1 having a means for individually adjusting the steering lines of a traction kite relative to one another or for collectively adjusting length of said steering lines relative to length of the de-powering (front) lines while flying said kite.

6. The device of claim 5, having a plurality of knots in steering leader lines which engage behind slots in each bar end fixture to adjust lengths of said steering lines, with a means for securing excess line.

7. The device of claim 5, having a pair of cam cleats on each bar end fixture to fix position of the leader lines, also having a provision for securing excess line.

8. The device of claim 5 having a lockable reel on each end fixture to fix position of, and secure surplus of leader lines.

9. The device of claim 1 having a means of transferring gripping force to retain a releasable end of the harness line.

10. The device of claim 9 having a mechanical or fluid actuated means transferring grip force to retain harness while allowing control bar to swivel with relation to said retention means.

11. The device of claim 1 having a means of retracting control bar toward a line-mounted release means, sliding on the taught, rider-attached harness line, until striking said release means, causing it to release said harness line and rider, after rider releases grip on said control bar.

12. The device of claim 11 having one or more elastic cords attached to the center of control bar and running forward to attach to one or both front (de-power) lines of the kite.

13. The device of claim 11 having an elastic core inside each steering line leader capable of providing sufficient retraction force, but not so much as to disturb kite control.

14. The device of claim 1 having a means for activating a release mounted on the control bar or de-powering leader line, which is releasably attached to rider's wrist by a tether of a length such that a release of control bar will activate said harness release.

15. The device of claim 14, which has a means of attaching tether to rider's wrist by a cuff, to which the tether is attached by a device designed to slip free at a pre-set tension, which may be adjusted by the user.

16. A method for releasing the harness line from a traction kite to a rider by a means actuated by release of the control bar from rider's grip, consisting of:
a. rider releasing his grasp on the control bar and
b. the releasing of the rider from the harness line, whereby rider is prevented from being dragged by an uncontrolled kite and possible resulting injury; with no other action being required of the rider at the instant of loss of control, other than to release the bar; usually an automatic response.
